(19) United States
(12) Patent Application Publication
(10) Pub. No.: US 2022/0064405 A1
(43) Pub. Date: Mar. 3, 2022

(54) METHOD OF INJECTION MOLDING RECYCLED POLYAMIDE POWDER AND PARTS FORMED BY THE METHOD

(71) Applicant: Ford Global Technologies, LLC, Dearborn, MI (US)

(72) Inventors: Alper Kiziltas, Sarikamis (TR); Qingkai Meng, Montreal (CA); Deborah Frances Mielewski, Ann Arbor, MI (US)

(73) Assignee: Ford Global Technologies, LLC, Dearborn, MI (US)

(21) Appl. No.: 17/006,950

(22) Filed: Aug. 31, 2020

(51) Int. Cl. C08K 5/098; C08J 11/06

(52) U.S. Cl. CPC C08K 5/098; C08J 2377/06; C08J 11/06

(57) ABSTRACT

A method of manufacturing an injection molded part includes formulating recycled polyamide material from a waste polyamide powder with at least one crystallization agent and at least one lubricant agent, forming recycled polyamide pellets from the recycled polyamide material, and injection molding a part from the recycled polyamide pellets. The crystallization agent is a metal salt of an organic acid with a content in the recycled polyamide material, in weight percent, between 0.1% and 1.0%, and the lubricant agent is a metal stearate with a content between 100 ppm to 5000 ppm. The waste polyamide powder is waste polyamide powder from a selective laser sintering process, for example waste polyamide 12 powder. Also, the waste polyamide 12 powder is not graded before forming the recycled polyamide material.

### FIELD

The present disclosure relates to injection molding and injection molded parts, and particularly, to injection molding using recycled additive manufacturing waste.

### BACKGROUND

The statements in this section merely provide background information related to the present disclosure and may not constitute prior art.

Additive manufacturing (AM), also known as 3D printing, provides a cost and time efficient process for making parts or components such as prototype parts and small batches of parts, among others, since capital expenditures for equipment such a molding machines and molding dies are not required. One type of AM process is selective laser sintering (SLS) in which a laser sinters powder material such as nylon or polyamide powder to create a solid structure.

Advances in AM equipment and AM techniques have decreased the cost and increased the size, complexity, and number of parts (i.e., batch size) that can be additively manufactured. However, such AM advances have resulted in an increase in powder that cannot be reused in AM processes (i.e., waste powder) and such waste powder is typically disposed of in landfills or waste incinerators.

The present disclosure addresses the issues of AM waste powder among other issues related to AM.

### SUMMARY

In one form, a method of manufacturing an injection molded part includes formulating recycled polyamide material from a waste polyamide powder with at least one crystallization agent and at least one lubricant agent, forming recycled polyamide pellets from the recycled polyamide material, and injection molding a part from the recycled polyamide pellets.

In some variations, the waste polyamide powder is waste polyamide powder from a selective laser sintering (SLS) process. And in at least one variation the waste polyamide powder is waste polyamide 12 powder and the recycled polyamide material is recycled polyamide 12 material.

In some variations, the waste polyamide powder is from a selective laser sintering (SL) process that is not graded before formulating to form the recycled polyamide material. For example, the waste polyamide powder is not graded before forming the recycled polyamide pellets.

In at least one variation, the crystallization agent is a metal salt of an organic acid. In some variations, the organic acid is benzoic acid. In at least one variation, the crystallization agent is at least one of sodium benzoate (C₆H₅COONa), potassium benzoate (C7H5KO₂), and calcium benzoate (Ca(C7H₅O₂)₂). In some variations, the recycled polyamide material comprises, in weight percent, between 0.1% and 1.0% of the crystallization agent.

In at least one variation, the lubricant agent is a metal stearate. In some variations, the lubricant agent is at least one of zinc stearate, calcium stearate, and magnesium stearate. In some variations, the recycled polyamide material comprises between 100 ppm to 5000 ppm of the lubricant agent.

In at least one variation, the recycled polyamide material comprises, in weight percent, between 0.1% and 1.0% of the crystallization agent and between 100 ppm to 5000 ppm of the lubricant agent. And in some variations, the crystallization agent is a metal salt of an organic acid and the lubricant agent is a metal stearate.

In another form of the present disclosure, injection molding material includes recycled polyamide 12 pellets formulated from a waste polyamide 12 powder with at least one crystallization agent and at least one lubricant agent. In some variations, the waste polyamide 12 powder is waste polyamide powder from a selective laser sintering (SLS) process. In at least one variation, the recycled polyamide 12 pellets comprise, in weight percent, between 0.1% and 1.0% of the crystallization agent and between 100 ppm to 5000 ppm of the lubricant agent.

In still another form of the present disclosure, an injection molded part formed according to a method includes formulating recycled polyamide material from a waste polyamide powder with at least one crystallization agent and at least one lubricant agent, forming recycled polyamide pellets from the recycled polyamide material, and injection molding a part from the recycled polyamide pellets. In some variations, the recycled polyamide pellets comprise, in weight percent, between 0.1% and 1.0% of the at least one crystallization agent.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The present disclosure will become more fully understood from the detailed description and the accompanying drawings, wherein:

FIG. 1 is a flow chart for a method of making recycled polyamide 12 powder for injection molding according to the teachings of the present disclosure;

FIG. 2 is a flow chart for a method of making an injection molded part out of recycled polyamide 12 powder according to the teachings of the present disclosure;

FIG. 3 is a perspective view of injection molded fuel line clips formed from recycled polyamide (rPA) 12 according to method in FIG. 2; and

FIG. 4 is a differential scanning calorimetry (DSC) plot of heat flow versus temperature for virgin polyamide 12 and recycled polyamide 12 according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features. Examples are provided to fully convey the scope of the disclosure to those who are skilled in the art. Numerous specific details are set forth such as types of specific components and devices to provide a thorough understanding of variations of the present disclosure. It will be apparent to those skilled in the art that specific details need not be employed and that the examples provided herein, may include alternative forms or variations and are not intended to limit the scope of the disclosure. In some examples, well-known processes, well-known device structures, and well-known technologies are not described in detail.

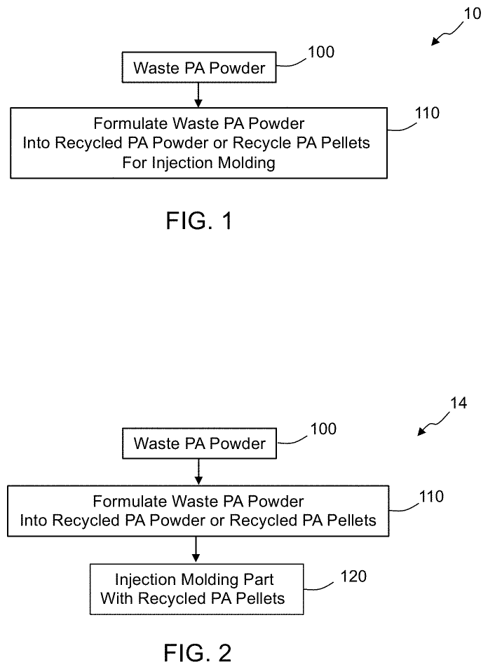

Referring to FIG. 1, a flow chart for a method 10 of forming recycled polyamide (rPA) powder according to the teachings of the present disclosure is shown. The method 10 includes starting with waste polyamide (PA) powder from an additive manufacturing (AM) process at 100 and formulating the waste PA powder into rPA powder or rPA pellets at 110 that can be used in an injection molding machine to form an injection molded part. As used herein, the term “waste” refers to powders that have been used at least once during an AM process, e.g., a selective laser sintering (SLS) process.

In some variations, the waste PA powder is waste polyamide 12 (PA12) powder, the rPA powder is rPA12 powder and the rPA pellets are rPA12 pellets. It should be understood that PA12, also known as nylon 12, is made from polycondensation of ω-aminolauric acid, a bifunctional monomer with one amine and one carboxylic acid group, or by ring-opening polymerization of laurolactam. Also PA12 has a density of 1.01 grams per milliliter (g/mL) and a melting temperature range between 178−180° C. (352-356° F.).

The waste PA12 powders disclosed herein have experienced heat damage from an AM process and if used in a subsequent AM process result in an AM produced part having less than desired physical, thermal, and/or mechanical properties. The waste PA12 powders have an average diameter of less than 100 μm, for example, between 10 μm and 90 μm, between 20 μm and 80 μm, between 30 μm and 70 μm, between 40 μm and 70 μm, and/or between 50 μm and 70 μm.

In addition, in some variations the rPA12 powder is used to replace other polyamide powders. For example, in at least one variation waste PA12 powder is pelletized into rPA12 pellets and used to replace virgin polyamide 66 pellets for injection molding. It should be understood that PA66, also known as nylon 66, is made from the monomers hexamethylenediamine and adipic acid, both of which contain 6 carbon atoms. Also PA 66 has a density of 1.314 g/mL and a melting temperature of 264° C. (507° F.).

Referring to FIG. 2, a flow chart for a method 14 of forming an injection molded part according to the teachings of the present disclosure is shown. The method 14 steps 100 and 110 shown and discussed above with reference to FIG. 1, and further includes injection molding a part with or from the rPA pellets at 120.

As noted above, in some variations the waste PA powder is waste PA12 powder, and the rPA powder is rPA12 powder and/or the rPA pellets are rPA12 pellets. In such variations, formulating the waste PA12 powder into rPA12 powder or rPA12 pellets at 110 includes changing the composition and/or structure of the waste PA12 powder such that injection molding of parts using the rPA12 powder or rPA12 pellets provides parts with desired mechanical, thermal, physical, and geometric properties. Particularly, the rPA12 powder or rPA12 pellets provides for injection molding of parts without short shots, long cycle times, and/or sticking (adhesion) of injection molded parts to a mold cavity surface(s) during and/or after the injection molding process. As used herein, the phrase “short shot” or “short shots” refers to incomplete filling of a mold cavity during injection molding a part such that an incomplete part is formed. Stated differently, solidification of the material being injection molded before a flow path(s) and mold cavity have been completely filled results in an incomplete part being formed and such incomplete filling of the mold cavity is known as a “short shot.” As used herein the phrase “long cycle time” or “long cycle times” refers to total cycle time, i.e., an elapsed time from a start time of injection molding a first part to a start time of injection a second part being longer than 25 seconds.

In some variations, the rPA12 is formulated from waste PA12 with at least one crystallization agent and at least one lubricant agent such that injection molded rPA12 parts are manufactured with no short shots, a cycle time of less than 25 seconds, and no sticking of injected molded parts. The at least one crystallization agent increases a crystallization temperature of the waste PA12 and thereby reduces the cycle time for injection molding parts from the rPA12. That is, it should be understood that the time to cool an rPA12 injection molded part from an injection temperature to a crystallization temperature of the rPA12 influences, and in some variations dominates, the cycle time of the injection molding process. And the closer the crystallization temperature of the material is to the injection temperature (i.e., the less difference between the injection temperature and the crystallization temperature), the faster (with respect to time) the injection molded part solidifies and can be removed from the mold cavity.

In some variations, metal salts of organic acids are used as a crystallization agent. For example, salts of benzoic acid (C7H₆O₂) are used as a crystallization agents. Non-limiting examples of salts of benzoic acid include sodium benzoate (C₆H₅COONa), potassium benzoate (C₇H₅KO₂), calcium benzoate (Ca(C₇H₅O₂)₂), among others. Other non-limiting examples of crystallization agents include inert fillers such as kaolin, chalk, clay, among others, and pigments such as phthalocyanine blue, among others.

The at least one lubricant agent decreases adhesion between the injection molded rPA12 parts and mold cavity surfaces such that desired mold release (i.e., no sticking) of injection molded rPA12 parts is provided. In some variations, metal stearates are used as the lubricant agent include zinc stearate, calcium stearate, magnesium stearate, among others. Other non-limiting examples of lubricant agents include stearic acid esters, glycerol monostearate, acrylic copolymers, fatty acid amines, primary amides, secondary amides and silicone oils, among others.

In order to illustrate the benefits of using rPA powder, e.g., rPA12 pellets, for injection molding of parts while not limiting the scope of the present disclosure, the following example is provided.

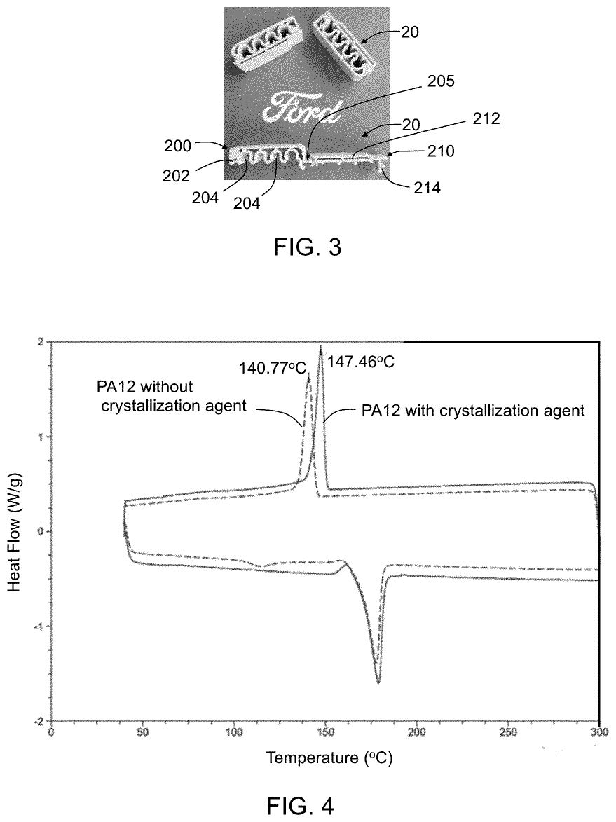

Injection molding of fuel line clips 20 shown in FIG. 3 using virgin polyamide 66 (PA66) material and rPA12 material was investigated. The fuel line clips 20 have a first half 200, a second half 210, and a living hinge 205 between the first half 200 and the second half 210. The first half 200 has a catch 202 and a plurality of fuel line holders 204, and the second half 210 includes a cover 212 and a latch 214. During assembly of a vehicle, the fuel line clip 20 is in an open position and one or more fuel lines (not shown) are positioned within the fuel line holders 204 of the first half 200 when the fuel line clip 20. Then, the second half 210 is rotated or pivoted over the first half 200 and the latch 214 engages the catch 202 such that the one or more fuel lines are securely held within the fuel line holders 204 between the first half 200 and the second half 210. In some variations, the fuel line holders 204 are dimensioned such that an interference fit is provided between each of the fuel line holders 204 and a fuel line disposed therein. Accordingly, the fuel line clips 20 exhibit desired strength, elasticity, and ductility.

The injection molding of the fuel line clips 20 using virgin PA66 material included feeding virgin PA66 pellets into a Battenfeld TC-40 injection molding machine with injection temperatures of 282° C. (540° F.) in a first zone, 277° C. (530° F.) in a second zone, and 271° C. (520° F.) in a third zone. However, a cycle time for injection molding a plurality of fuel line clips 20 from the virgin PA66 material was not obtained due to sticking, short shots and/or long cycle times.

The injection molding of the fuel line clips 20 using rPA12 material included feeding rPA12 pellets into the Battenfeld TC-40 injection molding machine with injection temperatures of 227° C. (440° F.) in the first zone, 221° C. (430° F.) in a second zone, 221° C. (430° F.) in the third zone, a metering time of about 5.5 seconds, an injection time of about 0.94 seconds, and a total cycle time of about 18.5 seconds. Also, there were no short shots during injection molding of the fuel line clips 20 and there was no sticking of the fuel line clips 20 to the mold cavity surface.

The rPA12 pellets were obtained from formulating waste PA12 powder from a Hewlett-Packard (HP®) Jet Fusion 3D printer. The waste PA12 powder was formulated with between 0.2 to 0.4 wt. % sodium benzoate and between 500 ppm to 2000 μm calcium stearate. Particularly, waste PA12 powder was fed from a main hopper into a twin screw extruder using a gravimetric feeder of a Reduction Engineering S3500 pelletizer. The sodium benzoate and calcium stearate were mixed together in a propeller mixer and then fed into the twin screw extruder using another (small) gravimetric feeder. The waste PA12 powder, the sodium benzoate, and calcium stearate were melt compounded in the twin screw extruder and a plastic melt was extruded through an end of an extruder to form melt strands. The melt strands were cooled and solidified on a water slide, pelletized, and sieved in a shaker to provide rPA12 pellets with an average pellet size of 3 mm. The final rPA12 pellets were discharged to a gayload box at the end of the pelletizing process.

After formulating the rPA12 pellets, differential scanning calorimetry (DSC) of the material was performed on the rPA12 pellets with a heat flow versus temperature plot shown plot in FIG. 4. The sodium benzoate raised the crystallization temperature of the rPA12 material from about 141° C. to about 147° C. as shown in FIG. 4. That is, the crystallization temperature of the waste PA12 material was raised about 7° C., thereby reducing the cycle time for injection molding of the material. In addition, the calcium stearate increased the fluidity and/or the mold release of the injection molded parts, thereby enhancing the injection molding properties of the PA12 material such that desired parts were formed.

It should be understood that PA12 is a desired material for AM since the material exhibits desired mechanical and thermal properties. However, the use of PA12 in injection molding has not been desirable due to the relatively large difference between an injection temperature and the crystallization temperature of PA12, thereby resulting in long cycle times, and sticking/adhesion of injection molded PA12 parts to mold cavity surfaces. Stated differently, prior attempts to injection mold parts formed from PA12, and waste PA12, with acceptable cycle times and desired mold release have not been successful. Accordingly, the rPA12 powder provides for injection molding of PA12 parts with no short shots, desired cycle times, and desired mold release.

In this manner, the waste PA12 powder is recycled and not discarded as waste in landfills, waste incinerators, etc. Also, the virgin PA12 powder is supplied or provided for AM with a generally uniform particle size and the rPA12 powder does not have to be graded (i.e., sifted for size uniformity) before being pelletized. It should be understood that use of the waste rPA12 powder to form rPA12 powder or rPA12 pellets without being graded reduces the overall time and cost of producing injection molded parts from virgin PA12 powder formulated for AM. That is, since the waste PA12 powder has been graded for the purpose of being used in the AM process, the waste rPA12 powder has a uniform size and does not need to graded again before being pelletized.

While the present disclosure discusses recycling PA12 powder for injection molding processes, it should be understood that other polyamide materials and other polymer materials not known for suitable use in injection molding can be formulated according to the teachings of the present disclosure, and after formulation, be suitable for injection molding of parts.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, manufacturing technology, and testing capability.

The description of the disclosure is merely exemplary in nature and, thus, variations that do not depart from the substance of the disclosure are intended to be within the scope of the disclosure. Such variations are not to be regarded as a departure from the spirit and scope of the disclosure.

As used herein, the phrase at least one of A, B, and C should be construed to mean a logical (A OR B OR C), using a non-exclusive logical OR, and should not be construed to mean “at least one of A, at least one of B, and at least one of C.

What is claimed is:

1. A method of manufacturing an injection molded part comprising:
formulating recycled polyamide material from a waste polyamide powder, wherein the waste polyamide powder is formulated with at least one crystallization agent and at least one lubricant agent;
forming recycled polyamide pellets from the recycled polyamide material; and
injection molding a part from the recycled polyamide pellets.

2. The method according to claim 1, wherein the waste polyamide powder is waste polyamide powder from a selective laser sintering (SLS) process.

3. The method according to claim 1, wherein the waste polyamide powder is waste polyamide 12 powder.

4. The method according to claim 1, wherein the recycled polyamide material is recycled polyamide 12 material.

5. The method according to claim 1, wherein the waste polyamide powder is from a selective laser sintering (SL) process that is not graded before formulating to form the recycled polyamide material.

6. The method according to claim 5, wherein the waste polyamide powder is not graded before forming the recycled polyamide pellets.

7. The method according to claim 1, wherein the crystallization agent is a metal salt of an organic acid.

8. The method according to claim 7, wherein the organic acid is benzoic acid.

9. The method according to claim 1, wherein the crystallization agent is at least one of sodium benzoate (C₆H₅COONa), potassium benzoate (C₇H₅KO₂), and calcium benzoate (Ca(C₇H₅O₂)₂).

10. The method according to claim 1, wherein the recycled polyamide material comprises, in weight percent, between 0.1% and 1.0% of the crystallization agent.

11. The method according to claim 1, wherein the lubricant agent is a metal stearate.

12. The method according to claim 1, wherein the lubricant agent is at least one of zinc stearate, calcium stearate, and magnesium stearate.

13. The method according to claim 1, wherein the recycled polyamide material comprises between 100 ppm to 5000 ppm of the lubricant agent.

14. The method according to claim 1, wherein the recycled polyamide material comprises, in weight percent, between 0.1% and 1.0% of the crystallization agent and between 100 ppm to 5000 ppm of the lubricant agent.

15. The method according to claim 14, wherein the crystallization agent is a metal salt of an organic acid and the lubricant agent is a metal stearate.

16. An injection molding material comprising:
recycled polyamide 12 pellets formulated from a waste polyamide 12 powder with at least one crystallization agent and at least one lubricant agent.

17. The injection molding material according to claim 16, wherein the waste polyamide 12 powder is waste polyamide powder from a selective laser sintering (SLS) process.

18. The injection molding material according to claim 16, wherein the recycled polyamide 12 pellets comprise, in weight percent, between 0.1% and 1.0% of the crystallization agent and between 100 ppm to 5000 ppm of the lubricant agent.

19. An injection molded part formed according to a method comprising:
formulating recycled polyamide material from a waste polyamide powder, wherein the waste polyamide powder is formulated with at least one crystallization agent and at least one lubricant agent;
forming recycled polyamide pellets from the recycled polyamide material; and
injection molding a part from the recycled polyamide pellets.

20. The injection molded part according to claim 19, wherein the recycled polyamide pellets comprise, in weight percent, between 0.1% and 1.0% of the at least one crystallization agent.
